(19) United States
(12) Patent Application Publication
(10) Pub. No.: US 2006/0174736 A1
(43) Pub. Date: Aug. 10, 2006

(54) Slitter knife system and method

(76) Inventors: Aaron Bloy, Peachtree City, GA (US); Mark Sisk, Hampton, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/055,156

(22) Filed: Feb. 10, 2005

(51) Int. Cl. B26D 1/00; B26D 7/26

(52) U.S. Cl. 83/13; 83/698.11

(57) ABSTRACT

A slitter knife system and method, wherein temporary application of air pressure is utilized to facilitate removal of a slitting knife from a slitting knife assembly. The present invention comprises a rotary spindle shaft assembly from which extends a mechanically-coupled spring-loaded piston. A slitting knife is maintained upon the spindle shaft assembly, and around the piston, via cooperative engagement of a retaining cap over the piston, wherein the compressive spring forces associated with the piston lock the retaining cap therewith. The spindle shaft assembly further comprises an air channel that extends to the rear of the piston, wherein a momentary application of air pressure through the air channel overcomes the compressive spring forces associated with the piston and, thus, urges the piston upward; thereby, enabling removal of the retaining cap therefrom, and access to the damaged or dulled slitting knife for replacement of same.

### TECHNICAL FIELD

The present invention relates generally to industrial slitting machines, and more specifically to a slitter knife system and method for facilitating safe and expeditious replacement of slitting or cutting knives disposed within such slitting machines.

### BACKGROUND OF THE INVENTION

Industrial slitting machines are commonly utilized to slit or cut continuous streams of a selected material into a plurality of strips for a variety of commercial uses. Examples of such materials often include continuous webs of woven or non-woven polyolefin, polyethylene, polypropylene, vinyl or other composite plastic films, and may further include continuous streams of paper, fibrous materials, textiles, scrim, and other flexible fabrics, materials, or substrates. Indeed, the development of roll stock of a particular material (i.e., bag substrate for form, fill and seal machines, wallpaper, fabric rolls, and the like) is often the product of such slitting machines.

Traditional slitting machines usually comprise a series of circular or disk-like rotary slitting knives that overlap or engage a respective series of powered blades, or powered bladed rollers, to provide a shearing action for slitting the continuous rolls of material passed or otherwise pulled therebetween and therethrough. The rotary slitting knifes are typically non-powered and, thus, are imparted with rotational motion via the powered blades or powered bladed rollers. Additionally, each rotary slitting knife is often disposed within a separate housing mounted to a support structure of the slitting machine, wherein the housings enable operator access to each of the rotary slitting knife assemblies therewithin.

As would be expected, long-term, continued and regular use of the rotary slitting knives inherently results in damage, wear or dulling of the bladed edges thereof; thus, requiring regular replacement of each such rotary slitting knife so as to not compromise the quality of product output. Unfortunately, however, the traditional design of rotary slitting knife assemblies makes replacement of the slitting knife a time-consuming and costly process, as the slitting machine must be non-operational for extended periods of time.

Specifically, some rotary slitting knife assemblies comprise a series of bolts and/or retaining ring arrangements that must be loosened or fully removed prior to extraction of the knife housing and/or the damaged or dulled slitting knife, wherein following replacement of the slitting knife, the entire assembly must be re-secured. Accordingly, in view of the plurality of slitting knife assemblies mounted within the common slitting machine, the time-delay associated with replacement of each slitting knife in each such bolted knife assembly is considerably magnified. As an additional disadvantage, such bolted knife assemblies present significant safety hazards, as regular rotational operation of the rotary knife assemblies may result in loosening of the bolts and, thus, forceful ejection of the slitting knifes therefrom.

In an attempt to avoid the lengthy delays, costs, and safety hazards associated with the foregoing bolted slitting knife assemblies, some slitting knife designs propose the application of a constant source of air pressure to retain or secure the slitting knife against a support member of the knife assembly. Such designs often generally comprise a configuration of spring-loaded plungers that each extend from bores formed through an arbor upon which the slitting knife rests. The plungers are catchably received through guide apertures formed in a clamp member placed over the arbor and against the slitting knife. Application of a constant source of air pressure through channels formed in the arbor draws the plungers inward toward the bores of the arbor and, thus, forces the clamp member to tightly bear against the slitting knife. Accordingly, to replace the slitting knife, air pressure is withdrawn or released, whereupon the plungers are springfully-urged upward; thus, enabling removal of the clamp member and the underlying slitting knife. Examples of such slitting knife assemblies may be seen with reference to U.S. Publication No. 2004/0149101A1 to Solberg, and U.S. Publication No. 2003/0188611A1, also to Solberg.

However, the foregoing slitting knife design utilizing a constant source of air pressure to retain or secure the slitting knife presents significant operational safety hazards. Specifically, because the slitting knife cannot be securely retained within the knife assembly without a constant source of air pressure acting on the plungers to force the clamp member against the slitting knife, loss of air pressure, due to loss of main power or otherwise, will result in the clamping member releasing force against the slitting knife and, thus, potential forceful ejection of the slitting knife from the arbor. Moreover, aside from the foregoing safety concerns, loss of air pressure alone would inherently render the slitting machine inoperable, as materials passed or pulled through the unstable or wobbling slitter knifes would be poorly cut, or remain uncut absent a proper shearing action between the slitting knives and the respective powered blades or powered bladed rollers.

Therefore, it is readily apparent that there is a need for a slitter knife system and method for facilitating safe and expeditious replacement of slitting knives disposed within a slitting machine. There is a further need for a slitter knife system and method that avoids application of a bolted knife arrangement, and the disadvantages thereof. There is a still further need for a slitter knife system and method that avoids application of a constant source of air pressure to retain or secure the slitting knife, but rather utilizes a momentary application of air pressure to facilitate removal of the slitting knife.

### BRIEF SUMMARY OF THE INVENTION

Briefly described, in a preferred embodiment, the present invention overcomes the above-mentioned disadvantages, and meets the recognized need for such a device by providing a slitter knife system and method, wherein temporary application of air pressure is utilized to facilitate removal of a slitting knife from a slitting knife assembly. The present invention comprises a rotary spindle shaft assembly from which extends a mechanically-coupled spring-loaded piston. A slitting knife is maintained upon the spindle shaft assembly, and around the piston, via cooperative engagement of a retaining cap over the piston, wherein the compressive spring forces associated with the piston lock the retaining cap therewith. The spindle shaft assembly further comprises an air channel that extends to the rear of the piston, wherein a momentary application of air pressure through the air channel overcomes the compressive spring forces associated with the piston and, thus, urges the piston upward; thereby, enabling removal of the retaining cap therefrom, and access to the damaged or dulled slitting knife for replacement of same.

According to its major aspects and broadly stated, the present invention in its preferred form is a slitter knife system and method, comprising a rotary spindle shaft assembly, a piston, a series of Belleville disc springs, a piston retaining cap, and a knife retaining cap, wherein an air channel formed through the spindle shaft assembly enables the passage of air pressure therethrough to facilitate removal of the slitting knife from the slitting knife assembly.

More specifically, the present invention comprises a piston having a base, shaft and head, and a series of Belleville disc springs disposed around the piston base. The piston head is preferably diametrically larger than the piston shaft, thereby collectively providing a flange or retaining lip.

A threaded piston retaining cap, preferably comprising an aperture for passage of the piston shaft and head therethrough, is threadably-engaged to a spindle plate of a rotary spindle shaft; thereby, compressing the disc springs disposed around the piston base, and forcefully maintaining the piston against the spindle plate. The piston retaining cap is preferably dimensioned such that upon full threading of same onto the spindle plate, and compression of the disc springs, a spatial gap remains between the upper side of the piston base and the underside of the piston retaining cap; thus, enabling lateral movement of the piston therewithin upon application of an air pressure.

Accordingly, preferably formed through the spindle shaft assembly, and extending through the spindle plate, is an air channel adapted to direct a pressurized air force against the underside of the piston base, thereby overcoming the compressive spring forces of the disc springs and, thus, urging the piston upward from the spindle plate. Upon application of such air pressure, a slitting knife and knife retaining cap may be coupled to the piston and spindle plate.

That is, the slitting knife is preferably maintained upon the spindle plate via cooperative engagement of a knife retaining cap with the piston head. Accordingly, to facilitate such engagement, the knife retaining cap preferably comprises first and second overlapping apertures, wherein the first aperture is dimension to receive the piston head therethrough, and wherein the second aperture is dimensioned to receive the piston shaft laterally-positioned or slidably engaged therewithin. As such, during momentary application of an air pressure through the spindle shaft air channel, and thus upward urging of the piston, the first aperture of the knife retaining cap is place over the piston head such that piston shaft is disposed within the first aperture. Thereafter, the knife retaining cap is preferably laterally shifted so as to position the piston shaft within the diametrically-smaller second aperture of the retaining cap.

Following positioning of the knife retaining cap over the piston head and shaft, delivery of air pressure is preferably ceased, resulting in release of stored compressed spring force by the disc springs and, thus, urging of the piston back toward the spindle plate. Consequently, the flange or retaining lip of the piston head is brought to forcefully bear against and within a recessed area surrounding the second aperture of the knife retaining cap; thus, locking the piston with the knife retaining cap. In such a configuration, the knife retaining cap securely maintains the slitting knife over the spindle plate.

To access, remove and replace a damaged or dulled slitting knife, a temporary application of air pressure is delivered through the air channel of the spindle shaft assembly to overcome the compressive spring forces associated with the piston and, thus, urge the piston upward; thereby, enabling lateral shifting and removal of the retaining cap therefrom, and thus extraction of the slitting knife from the spindle plate.

Accordingly, a feature and advantage of the present invention is its utilization of a momentary application of air pressure to facilitate safe and expeditious removal of a slitting knife from a slitting knife assembly.

Another feature and advantage of the present invention is its utilization of a momentary application of air pressure to facilitate safe and expeditious replacement of a slitting knife onto a slitting knife assembly.

Still another feature and advantage of the present invention is its utilization of a spring-loaded piston in combination with an arrangement of retaining caps to facilitate secured retention of a slitting knife within a slitting knife assembly.

Yet another feature and advantage of the present invention is its ability to avoid dependency upon a constant source or delivery of air pressure to secure the slitting knife within the slitting knife assembly and, thus, the disadvantages commonly associated with such slitter knife designs.

Still yet another feature and advantage of the present invention is its ability to avoid application of a bolted knife arrangement and, thus, the disadvantages commonly associated with such slitter knife designs.

A further feature and advantage of the present invention is its ability to facilitate safe and expeditious replacement of slitting knives disposed within a slitting machine and, thus, significantly reduce time-delays and costs associated with machine inoperability during such knife replacement processes.

These and other features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a cross-sectional view of a slitter knife system according to a preferred embodiment of the present invention, shown assembled;

FIG. 2 is an exploded view of a slitter knife system according to a preferred embodiment of the present invention;

FIG. 3 is a cross-sectional view of an outer housing of a slitter knife system according to a preferred embodiment of the present invention;

FIG. 4 is a cross-sectional view of a spindle shaft of a slitter knife system according to a preferred embodiment of the present invention;

FIG. 5 is a cross-sectional view of a spring pocket of a slitter knife system according to a preferred embodiment of the present invention;

FIG. 6 is a cross-sectional view of a sliding plunger of a slitter knife system according to a preferred embodiment of the present invention;

FIG. 7 is a cross-sectional view of a rear nut of a slitter knife system according to a preferred embodiment of the present invention;

FIG. 8 is a cross-sectional view of a piston of a slitter knife system according to a preferred embodiment of the present invention;

FIG. 9 is a cross-sectional view of a piston retaining cap of a slitter knife system according to a preferred embodiment of the present invention;

FIG. 10 is a top view of a knife retaining cap of a slitter knife system according to a preferred embodiment of the present invention;

FIG. 10A is a top view of a slitter knife system according to a preferred embodiment of the present invention; and,

FIG. 11 is a cross-sectional view of a slitter knife system according to a preferred embodiment of the present invention, shown assembled with a slitting knife secured thereto.

### DETAILED DESCRIPTION OF THE PREFERRED AND ALTERNATIVE EMBODIMENTS

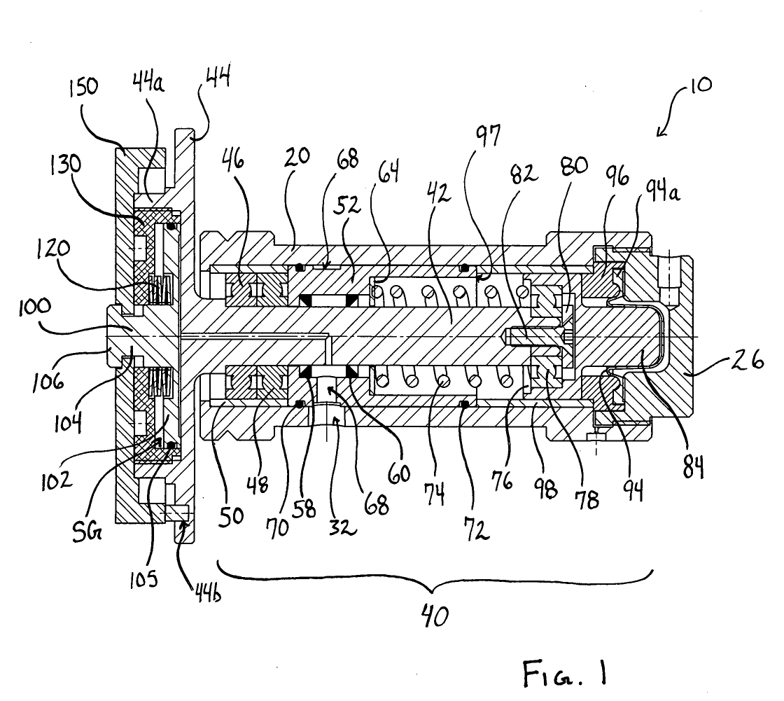

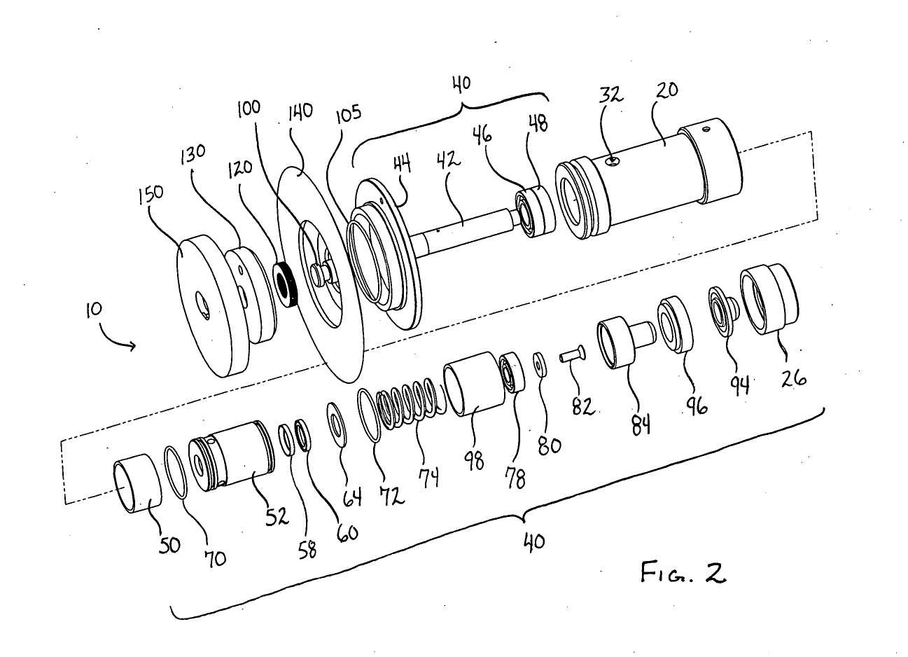

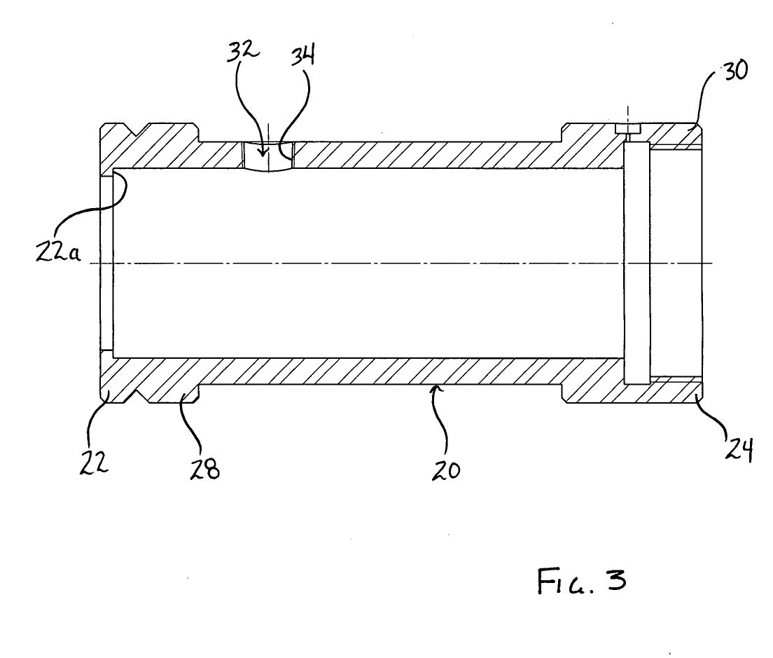

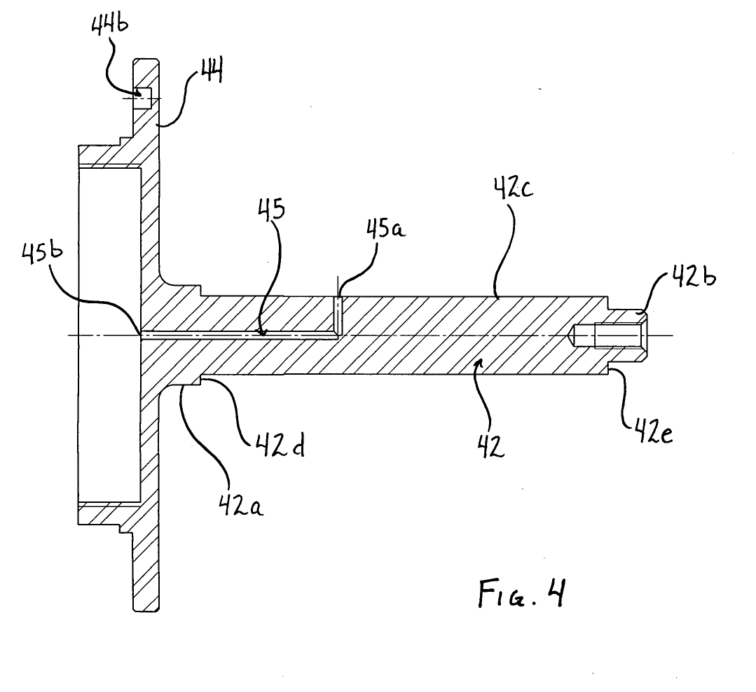

In describing the preferred and alternate embodiments of the present invention, as illustrated in FIGS. 1-11, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-11, the present invention in its preferred embodiment is a slitter knife system 10, comprising rotary spindle shaft housing 20, rotary spindle shaft assembly 40, piston 100, disc springs 120, piston retaining cap 130, and knife retaining cap 150.

Specifically, and with combined reference now to FIGS. 1-3, tubular-shaped housing 20 preferably comprises proximal end 22 and distal end 24, wherein proximal end 22 preferably comprises retaining lip 22a, and wherein distal end 24 is adapted to threadably receive rear nut 26. Accordingly, all component parts of rotary spindle shaft assembly 40 are preferably housed and retained within housing 20, between retaining lip 22a of proximal end 22, and rear nut 26, wherein the specific structural and operative assembly of all component parts of rotary spindle shaft assembly 40 is more fully described below. Moreover, housing 20 preferably comprises flanges 28, 30 for facilitating stationary mounting of housing 20 within a selected slitting machine.

Preferably formed through housing 20 is air hose aperture 32, fitted with threaded bushing 34. Accordingly, when slitter knife system 10 is in use, an air supply hose is threadably secured to busing 34 for directing pressurized air through aperture 32 and, thereafter, through an air channel arrangement of rotary spindle shaft assembly 40, as more fully described below.

With combined reference now to FIGS. 1-4, rotary spindle shaft assembly 40 preferably comprises spindle shaft 42, having proximal end 42a and distal end 42b, wherein spindle plate 44 is preferably integrally formed with, and perpendicularly disposed to, proximal end 42a of spindle shaft 42. During assembly of slitter knife system 10, spindle shaft 42 is preferably inserted through proximal end 22 of housing 20, and all remaining component parts of rotary spindle shaft assembly 40 functionally engaged therearound and thereto.

Spindle shaft 42 further preferably comprises air channel 45, wherein air channel 45 comprises first end 45a formed through exterior side 42c of spindle shaft 42, and second end 45b preferably centrally-disposed and extending through spindle plate 44. Pressurized air directed through aperture 32 of housing 20 preferably travels through air channel 45 of spindle shaft 42 and forcefully acts against piston 100 for facilitating the removal or replacement of a slitting knife on spindle plate 44, as more fully described below.

Preferably formed on proximal end 42a of spindle shaft 42 is retaining lip 42d, upon which are seated ball bearing assemblies 46, 48, wherein bearing assemblies 46, 48 encircle proximal end 42a of spindle shaft 42; thereby, imparting spindle shaft 42 with rotational capabilities. Preferably disposed around bearing assemblies 46, 48, and seated on retaining lip 22a of proximal end 22 of housing 20, is tubular-shaped sleeve 50, wherein sleeve 50 is preferably coated with a polymer having a low coefficient of friction, such as, for exemplary purposes only, polytetrafluoroethene (i.e., TEFLON) perfluoroalkoxy polymer resin, or the like. Sleeve 50 preferably enables bearing assemblies 46, 48 to slide therewithin and, thus, facilitate the lateral positional displacement or slidable movement of spindle shaft 42 within housing 20 during operation of slitter knife system 10, as more fully described below.

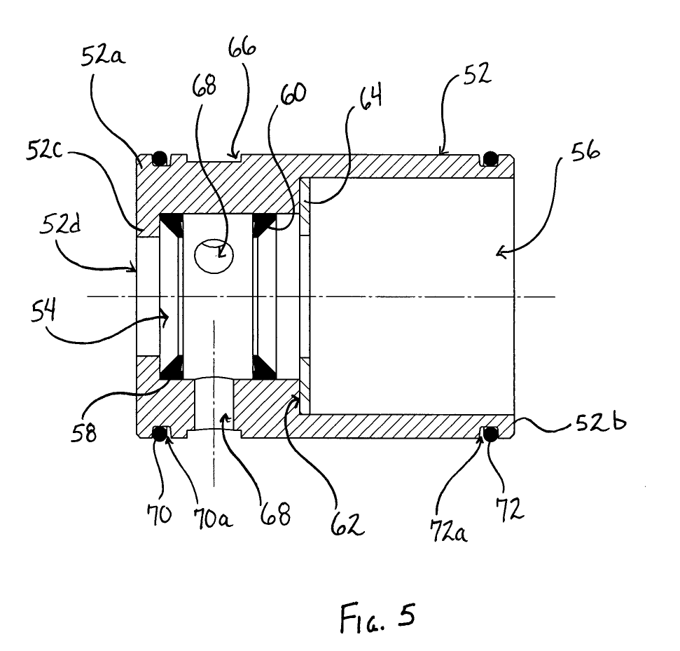

Referring now more specifically to FIG. 5, with continued reference to FIGS. 1-4, preferably seated on bearing assemblies 46, 48 and sleeve 52 is tubular-shaped spring pocket 52. Spring pocket 52 comprises proximal end 52a and distal end 52b, wherein proximal end 52a comprises peripheral flange 52c dimensioned to reduce the diameter of aperture 52d of spring pocket 52 to effectively accommodate the diameter of spindle shaft 42, yet enable unrestricted rotational movement of spindle shaft 42 therewithin.

Spring pocket 52 is characterized as having first inner space 54 and second inner space 56. The boundary of first inner space 54 is preferably defined by rubber seal rings 58, 60, wherein seal ring 58 is seated against flange 52c of spring pocket 52, and wherein seal ring 60 is preferably disposed proximate inner ledge 62 of spring pocket 52. Rubber seal rings 58, 60 preferably encircle and frictionally contact, or sealably engage, exterior side 42c of spindle shaft 42 to prevent passage of air beyond first inner space 54. As best illustrated in FIG. 1, when spindle shaft 42 is fully recessed within housing 20, and extended through spring pocket 52, first end 45a of air channel 45 of spindle shaft 42 preferably resides within first inner space 54 of spring pocket 52, and is flanked between seal rings 58, 60 thereof.

Preferably formed through and disposed within annular surface groove 66 of spring pocket 52, and extending specifically into sealed first inner space 54 thereof, are apertures 68. Accordingly, pressurized air directed through aperture 32 of housing 20 preferably travels through and around surface groove 66, through apertures 68 of spring pocket 52, through first end 45a of air channel 45, exits second end 45b thereof, and forcefully acts on piston 100, as more fully described below.

To prevent introduction of air past spring pocket 52, as delivered through aperture 32 of housing 20, rubber O-rings 70, 72, disposed within annular grooves 70a, 72b, respectively, of spring pocket 52, and proximate respective ends 52a, 52b thereof, preferably sealably engage the inner surface or wall of housing 20.

Preferably seated on inner ledge 62 of spring pocket 52 is seal retaining washer 64, encircling spindle shaft 42. Seated on retainer washer 64, and substantially disposed within second inner space 56 of spring pocket 52, is coiled compression spring 74, wherein coiled compression spring is capped by another seal retaining washer 76. Preferably disposed atop seal retaining washer 76, and further supported on and encircling retaining lip 42e of distal end 42b of spindle shaft 42, is ball bearing assembly 78, wherein bearing assembly 78 contributes to the rotational capabilities of spindle shaft 42. Bearing assembly 78 is preferably retained atop distal end 42b of spindle shaft 42 via bearing retainer cap 80, wherein bearing retainer cap 80 is preferably secured to distal end 42b via flathead screw 82.

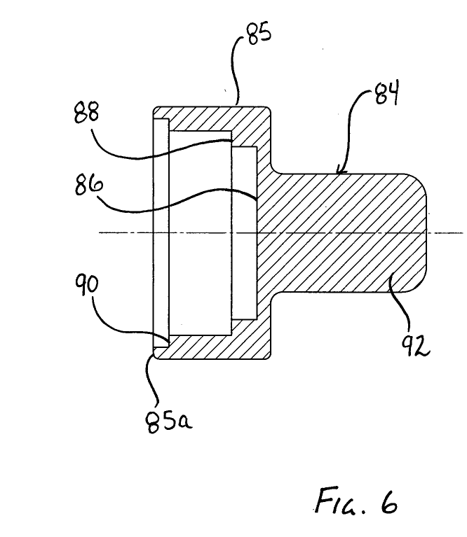

Referring now more specifically to FIG. 6, with continued reference to FIGS. 1-5, bearing retainer cap 80, bearing assembly 78, and seal retaining washer 76, are preferably received and seated within plunger cup 85 of sliding plunger 84. Specifically, bearing retainer cap 80 is seated within basin 86 of plunger cup 85; bearing assembly 78 is seated upon medial shelf 88 of plunger cup 85; and, seal retaining washer 76 is seated upon upper shelf 90 of plunger cup 85, substantially flush with upper peripheral edge 85a thereof. Stem 92 of plunger 84 is preferably draped or engaged with flexible rubber diaphragm ring 94, wherein peripheral lip 94a of diaphragm 94 is preferably securely fastened between diaphragm seal ring 96, disposed around plunger stem 92, and rear nut 26, threadably engaged to distal end 24 of housing 20.

Preferably seated against distal end 52b of spring pocket 52, and disposed substantially around plunger cup 85 of plunger 84, is tubular-shaped sleeve 98. Sleeve 98, like sleeve 50, is preferably coated with a polymer having a low coefficient of friction, such as, for exemplary purposes only, polytetrafluoroethene (i.e., TEFLON) perfluoroalkoxy polymer resin, or the like. Sleeve 98 preferably enables plunger 84 to slide therewithin and, thus, in conjunction with sleeve 50, facilitate the lateral positional displacement or slidable movement of spindle shaft 42 within housing 20 during operation of slitter knife system 10, as more fully described below. Notably, the wall thickness of tubular-shaped sleeve 98 is smaller than the wall thickness of spring pocket 52 and, as such, a ledge 97 is provided where sleeve 98 abuts distal end 52b of spring pocket 52. Ledge 97 particularly functions as a stopping block for plunger 84 during slidable movement of plunger 84 through sleeve 98.

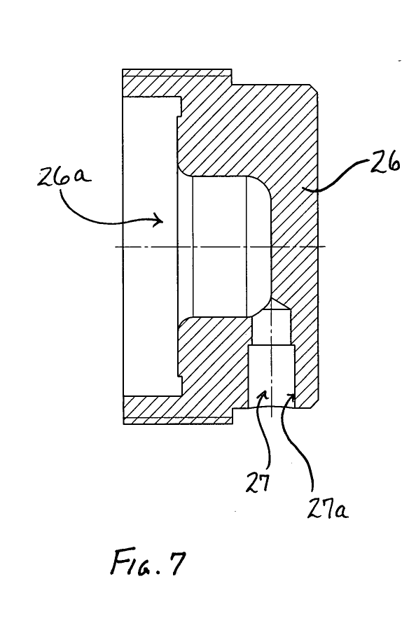

Referring now more specifically to FIG. 7, with continued reference to FIGS. 1-6, rear nut 26 preferably comprises depression 26a, dimensioned to receive the diaphragm-draped plunger stem 92 and engage diaphragm seal ring 94. Rear nut 26 further comprises air channel 27 formed therethrough and extending into depression 26a, wherein air channel 27 is fitted with threaded bushing 27a, adapted to threadably receive an air supply hose. Accordingly, when slitter knife system 10 is in operation, pressurized air is delivered through air channel 27 of rear nut 26 into depression 26a. The air pressure within depression 26a of rear nut 26 preferably balloons forward diaphragm 94, forcefully pushing against plunger stem 92 and, thus, urging plunger 84 slidably past sleeve 98, and bearing assemblies 46, 48 past sleeve 50; thereby, laterally positionally displacing or slidable moving communicating spindle shaft 42 within housing 20 and, thus, orienting the slitting knife carried by spindle shaft 44 in operable position with a powered blade or bladed roller. Sliding plunger 84 preferably comes to a halt upon peripheral edge 85a of plunger cup 85 contacting ledge 97, formed by adjacently-disposed sleeve 98 and spring pocket 52; thus, preventing over-extension of spindle shaft 42 from housing 20. When plunger cup 85 is in contact with ledge 97, coiled compression spring 74 disposed within spring pocket 52 is substantially compressed. As such, upon cessation of pressurized air through rear nut 26, compression spring 74 releases its stored energy and springfully urges plunger 84 back into rear nut 26 and, thus, communicating spindle shaft 42 back into a resting, non-operative position.

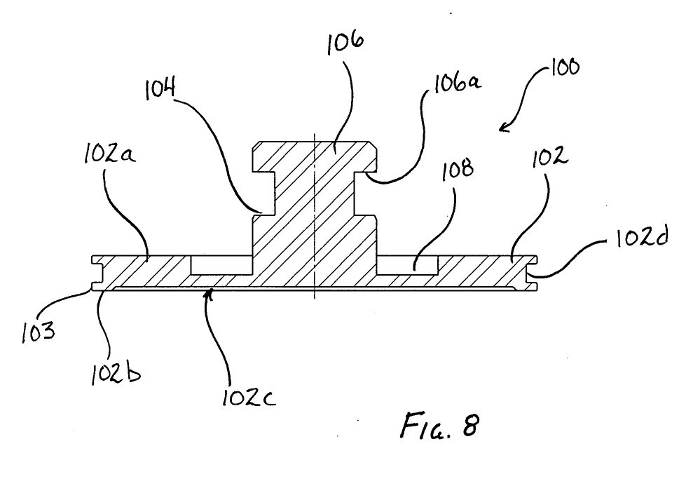

Referring now more specifically to FIG. 8, with continued reference to FIGS. 1-5, piston 100 comprises base 102, shaft 104 and head 106, and a series of Belleville disc springs 120 disposed within annular recess 108 formed on upper side 102a of piston base 102, and around shaft 104. Piston head 106 is preferably diametrically larger than piston shaft 104, thereby collectively providing a flange or retaining lip 106a, for purposes more fully described below.

Piston base 102 is preferably positioned within internally-threaded retaining wall 44a of spindle plate 44, wherein piston base 102 preferably further comprises depression 102c formed on underside 102b thereof. Depression 102c functions to provide the requisite area within which air pressure expelled through second end 45b of air channel 45 may accumulate and forcefully act to overcome the compressive forces of spring 120 and, thus, urge the piston 100 upward from spindle plate 44, as more fully described below.

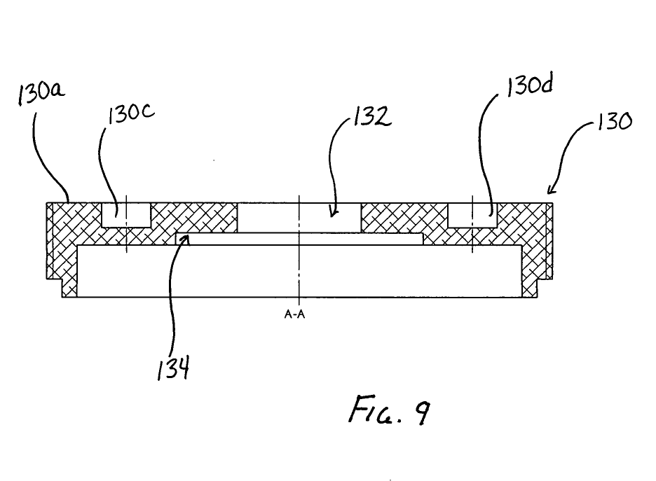

Referring now more specifically to FIG. 9, with continued reference to FIGS. 1-5, and FIG. 8, externally-threaded piston retaining cap 130, preferably comprising aperture 132 for passage of piston shaft 104 and piston head 106 therethrough, is placed over piston 100, and threadably-engaged to internally-threaded retaining wall 44a of spindle plate 44; thereby, compressing disc springs 120 disposed around piston base 104, and forcefully (i.e., through spring force) maintaining piston 100 against spindle plate 44. Underside 130b of piston retaining cap 130 preferably comprises recess 134 formed thereon, and around aperture 132 thereof, wherein recess 134 is dimension to accommodate disc springs 120 upon threaded engagement of piston retaining cap 130 with retaining wall 44a of spindle plate 44. Moreover, to facilitate threaded engagement of piston retaining cap 130 with retaining wall 44a, upper side 130a of piston retaining cap 130 preferably comprises leverage holes or divots for receiving a spanner wrench, or the like; however, other suitable methods of threadably engaging piston retaining cap 130 with retaining wall 44a may be utilized.

Piston retaining cap 130 is preferably dimensioned such that upon full threading of same onto retaining wall 44a of spindle plate 44, and compression of disc springs 120 therebeneath, spatial gap SG remains between upper side 102a of piston base 102 and underside 130b of piston retaining cap 130; thus, enabling lateral movement of piston base 102 therewithin upon application of an air pressure through air channel 45. That is, pressurized air expelled from second end 45 of air channel 45a through spindle plate 44 preferably imparts a pressurized air force against underside 102b of piston base 102; thereby, overcoming the compressive spring forces of disc springs 120 and, thus; urging piston base 102 upward from spindle plate 44, through the distance of spatial gap SG. To prevent seepage of air past piston base 102, rubber O-ring 105, preferably disposed within annular groove 103 formed around peripheral wall 102d of piston base 102, provides an effective seal between peripheral wall 102d and inner wall surface 130e of piston retaining cap 130; thus, ensuring sufficient accumulation of pressurized air within depression 102c of piston base 102 for effectively overcoming the compressive spring forces of disc springs 120. Although Belleville disc springs 120 are utilized, it should be recognized that other suitable springs may be utilized to provide the requisite compressive spring force.

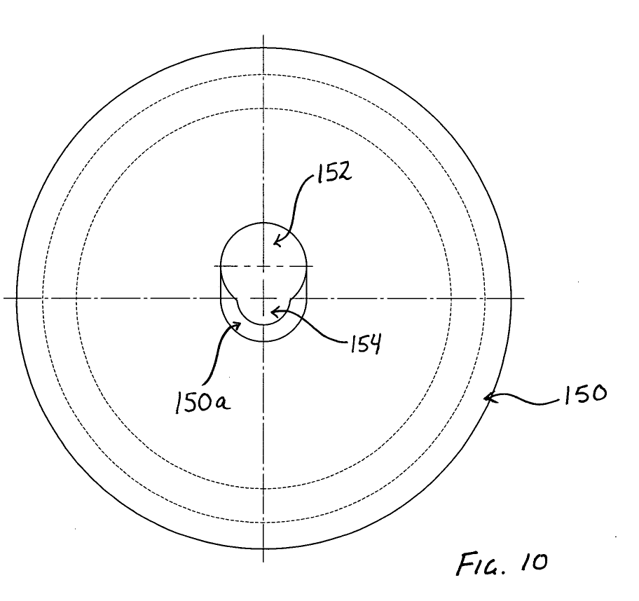

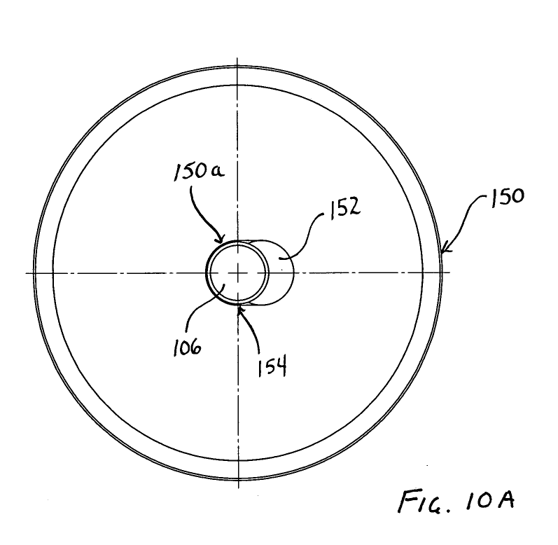

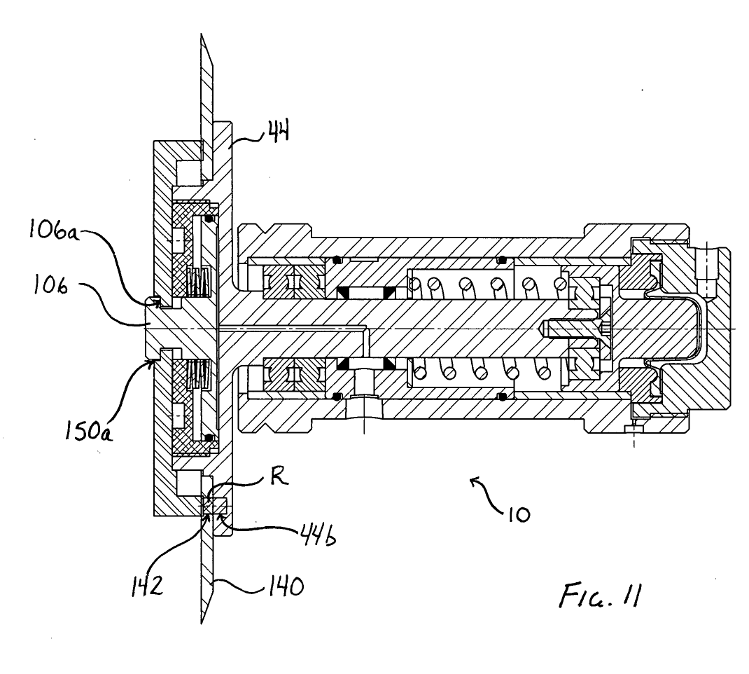

Referring now more specifically to FIGS. 10-11, with continued reference to FIGS. 1-5, and FIGS. 8-9, upon application of air pressure through air channel 45, knife retaining cap 150 may be coupled to piston 100 to secure slitting knife 140 to spindle plate 44. Specifically, slitting knife 140 is preferably securely maintained upon spindle plate 44, and around retaining wall 44a thereof, via cooperative engagement of knife retaining cap 150 with piston head 106. Accordingly, to facilitate such engagement, knife retaining cap 150 preferably comprises first and second overlapping apertures 152, 154, respectively. First aperture 152 is dimension to receive piston head 106 therethrough, wherein second aperture 154 is diametrically-smaller than first aperture 152 and, thus, dimensioned to receive piston shaft 104 laterally-positioned or slidably engaged therewithin. As such, during momentary application of an air pressure through air channel 45 of spindle shaft/plate 42, 44, and thus upward urging of piston 100 via the pressurized air force acting thereupon and overcoming the compressive springs forces of disc springs 120, first aperture 152 of knife retaining cap 150 is place over piston head 106 such that piston shaft 104 is disposed within first aperture 152. Thereafter, knife retaining cap 150 is preferably laterally shifted so as to position piston shaft 104 within the diametrically-smaller second aperture 154 of knife retaining cap 150.

Following positioning of knife retaining cap 150 over piston head 106 and piston shaft 104, delivery of air pressure through air channel 45 is preferably ceased, resulting in release of stored compressed spring force by disc springs 120 and, thus, urging of piston 100 back toward spindle plate 44. Consequently, flange or retaining lip 106a of piston head 106 is brought to forcefully bear against and within recessed area 150a surrounding second aperture 154 of knife retaining cap 150; thus, locking piston 100, and more specifically piston head 106, against knife retaining cap 150. In such a configuration, knife retaining cap 150 securely maintains slitting knife 140 over spindle plate 44.

To access, remove and replace a damaged or dulled slitting knife 140, a temporary application of air pressure is delivered through air channel 45 of spindle shaft/plate 42, 44 to overcome the compressive spring forces of disc springs 120 and, thus, urge piston 100 upward; thereby, enabling lateral shifting and removal of knife retaining cap 150 therefrom, and thus extraction of slitting knife 140 from spindle plate 44.

Slitting knife 140 is preferably extracted from spindle plate 44 and, thus, disengaged from roll pin R which extends from pinhole 44b of spindle plate 44 and through pin aperture 142 of slitting knife 140. (During operation of slitter knife system 10, roll pin R is preferably utilized to preclude independent rotation of slitting knife 140.) A new slitting knife 140 is preferably placed onto spindle shaft 44, wherein pin aperture 142 of slitting knife 140 is position and seated over roll pin R, and wherein knife retaining cap 150 is subsequently re-engaged over piston head 106.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A slitter knife system for facilitating the placement and removal of a slitting knife thereto, said slitter knife system comprising:
a support member;
means for retaining the slitting knife on said support member; and,
means for imparting a pressurized force to enable removal of at least a portion of said retaining means and, thus, the slitting knife from said support member.

2. The slitting knife system of claim 1, wherein said retaining means comprises a piston.

3. The slitting knife system of claim 2, wherein said piston is retained on said support member via a piston retaining cap.

4. The slitting knife system of claim 3, further comprising a spring disposed between said piston retaining cap and said piston, wherein said spring forcefully compresses and maintains said piston against said support member.

5. The slitting knife system of claim 4, wherein a spatial gap remains between said piston and said piston retaining cap, wherein said spatial gap enables lateral movement of said piston therewithin upon application of said means for imparting a pressurized force.

6. The slitting knife system of claim 5, whereupon application of said means for imparting a pressurized force acts on said piston to overcome compressive spring forces associated with said spring and, thus, urge said piston through said spatial gap and off said support member.

7. The slitting knife system of claim 6, wherein said retaining means further comprises a knife retaining cap removably engageable to said piston when said piston is urged off said support member.

8. The slitting knife system of claim 7, wherein said knife retaining cap comprises an aperture for receiving at least a portion of said piston therethrough, and wherein said aperture enables said knife retaining cap to be laterally-positioned or slidably engaged with said at least a portion of said piston.

9. The slitting knife system of claim 8, whereupon withdrawal of said means for imparting a pressurized force results in release of stored compressed spring force by said spring and, thus, urging of said piston back against said support member.

10. The slitting knife system of claim 9, whereupon urging of said piston back against said support member results in said at least a portion of said piston being brought to forcefully bear against and within a recessed area surrounding said aperture of said knife retaining cap; thus, forcefully locking said knife retaining cap against said piston.

11. The slitting knife of claim 10, wherein said means for imparting a pressurized force comprises an air channel formed through said support member.

12. The slitting knife of claim 11, wherein said air channel directs a pressurized air force against said piston to enable removal of said knife retaining cap from said piston and, thus, the slitting knife from said support member.

13. A slitter knife system for facilitating the placement and removal of a slitting knife thereto, said slitter knife system comprising:
a support member;
means for retaining the slitting knife on said support member; and,
an air channel disposed through said support member, wherein said air channel directs a pressurized air force against said retaining means to enable removal of at least a portion of said retaining means and, thus, the slitting knife from said support member.

14. The slitting knife system of claim 13, wherein said retaining means comprises a piston.

15. The slitting knife system of claim 14, wherein said piston is retained on said support member via a piston retaining cap.

16. The slitting knife system of claim 15, further comprising a disc spring disposed between said piston retaining cap and said piston, wherein said disc spring forcefully compresses and maintains said piston against said support member.

17. The slitting knife system of claim 16, wherein a spatial gap remains between said piston and said piston retaining cap, wherein said spatial gap enables lateral movement of said piston therewithin upon application of the pressurized air force through said air channel.

18. The slitting knife system of claim 17, whereupon the pressurized air force directed through said air channel acts on said piston to overcome compressive spring forces associated with said disc spring and, thus, urge said piston through said spatial gap and off said support member.

19. The slitting knife system of claim 18, wherein said retaining means further comprises a knife retaining cap removably engageable to said piston when said piston is urged off said support member.

20. The slitting knife system of claim 19, wherein said knife retaining cap comprises an aperture for receiving at least a portion of said piston therethrough, and wherein said aperture enables said knife retaining cap to be laterally-positioned or slidably engaged with said at least a portion of said piston.

21. The slitting knife system of claim 20, whereupon withdrawal of the pressurized air force results in release of stored compressed spring force by said disc spring and, thus, urging of said piston back against said support member.

22. The slitting knife system of claim 21, whereupon urging of said piston back against said support member results in said at least a portion of said piston being brought to forcefully bear against and within a recessed area surrounding said aperture of said knife retaining cap; thus, forcefully locking said knife retaining cap against said piston.

23. A method for removing a slitting knife from a slitting machine for replacement of the slitting knife, said method comprising the step of:
utilizing a pressurized air force to remove the slitting knife from the slitting machine.

24. The method of claim 23, further comprising the step of directing the pressurized air force against at least a portion of a retaining means utilized to retain the slitting knife within the slitting machine.

25. The method of claim 24, further comprising the step of at least momentarily overcoming the resistive forces of said retaining means.

26. The method of claim 25, wherein said step of at least momentarily overcoming the resistive forces of said retaining means comprises the step of overcoming compressive spring forces associated with said retaining means.

27. The method of claim 26, further comprising the step of removing at least a portion of said retaining means to access and remove the slitting knife for replacement of same.

28. The method of claim 27, further comprising the step of reengaging said at least a portion of said retaining means with said retaining means.

29. The method of claim 28, further comprising the step of withdrawing the pressurized air force to lock the reengaged said at least a portion of said retaining means with said retaining means, and thus secure the replacement slitting knife therewith.
